(19) United States
(12) Patent Application Publication
(10) Pub. No.: US 2025/0112715 A1
(43) Pub. Date: Apr. 3, 2025

(54) METHOD AND APPARATUS FOR USING ON-DEMAND REFERENCE SIGNAL OR SYSTEM INFORMATION BLOCK FOR NETWORK ENERGY SAVING

(71) Applicant: MEDIATEK INC., Hsinchu City (TW)

(72) Inventor: Chien-Chun CHENG, Hsinchu City (TW)

(21) Appl. No.: 18/832,724

(22) PCT Filed: Jan. 18, 2023
(86) PCT No.: PCT/CN2023/072801

§ 371 Date: Jul. 24, 2024

Related U.S. Application Data
(60) Provisional application No. 63/308,171, filed on Feb. 9, 2022.

(51) Int. Cl. H04B 17/327; H04L 5/00; H04W 74/0833

(52) U.S. Cl. CPC H04B 17/327; H04L 5/0048; H04W 74/0833

(57) ABSTRACT

Various solutions for using on-demand reference signal (RS) or system information block (SIB) for network energy saving with respect to user equipment and network apparatus in mobile communications are described. An apparatus may determine whether to trigger an on-demand RS/SIB or SIB request according to a trigger condition. The apparatus may transmit the on-demand RS/SIB or SIB request to a network node in an event that the trigger condition is satisfied. The apparatus may receive a response of the on-demand RS/SIB or SIB request from the network node. The apparatus may perform an on-demand RS/SIB or SIB measurement according to the response.

### CROSS REFERENCE TO RELATED PATENT APPLICATION(S)

The present disclosure claims the priority benefit of U.S. Provisional Patent Application No. 63/308,171, filed on 9 Feb. 2022. The contents of aforementioned applications are herein incorporated by reference in their entirety.

### TECHNICAL FIELD

The present disclosure is generally related to mobile communications and, more particularly, to using on-demand reference signal or system information block for network energy saving with respect to user equipment (UE) and network apparatus in mobile communications.

### BACKGROUND

Unless otherwise indicated herein, approaches described in this section are not prior art to the claims listed below and are not admitted as prior art by inclusion in this section.

5G network, despite its enhanced energy efficiency in bits per Joule (e.g., 417% more efficiency than a 4G network) due to its larger bandwidth and better spatial multiplexing capabilities, could typically consume over 140% more energy than a 4G network. This may bring an issue when the traffic load is lower than a certain threshold. The energy efficiency could be below the standard requirement since the traffic load could be low while the energy consumption is maintained. For example, nighttime may be characterized by lower traffic demands concerning daytime. If a network is configured to satisfy peak-time traffic, energy may be wasted during low and medium load periods. Thus, energy-saving mechanisms to adapt the network configurations are needed to achieve the energy efficiency requirement.

For low traffic load, the common signal may dominate network's power consumption. For example, up to 30% of symbols for frequency range 1 (FR1) and 15% of symbols for frequency range 2 (FR2) are active in time for the network only to transmit synchronization signal block (SSB) and SystemInformationBlockType1 (SIB1). As a result, 5G base station (BS) consumes a large amount of energy even when the load is almost zero (e.g., only SSB and system information (SI) transmissions are ongoing). SIB1 may not be broadcasted in a cell if a Master Information Block (MIB) indicates that the SIB1 is not broadcasted. However, in 3rd Generation Partnership Project (3GPP) Release-17, SSB signals are supposed to be “always-on.” A base station (e.g., gNB) may broadcast up to 8 (for FR1) and 64 (for FR2) SSBs with a minimum 5 millisecond (ms) periodicity in a cell. It is a clear waste of energy if no user data is required during a particular time or in a specific area of a network.

Accordingly, how to reduce network energy consumption and improve energy efficiency becomes an important issue for the newly developed wireless communication network. Therefore, there is a need to provide proper energy-saving schemes to adapt the network configurations for various traffic scenarios.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to using on-demand reference signal or system information block for network energy saving with respect to user equipment and network apparatus in mobile communications.

In one aspect, a method may involve an apparatus determining whether to trigger an on-demand reference signal (RS) request or an on-demand system information block (SIB) request according to a trigger condition. The method may also involve the apparatus transmitting the on-demand RS/SIB request to a network node in an event that the trigger condition is satisfied. The method may further involve the apparatus receiving a response of the on-demand RS/SIB request from the network node. The method may further involve the apparatus performing an on-demand RS/SIB measurement according to the response.

In one aspect, a method may involve an apparatus receiving an on-demand RS/SIB request from a user equipment (UE). The method may also involve the apparatus determining a response according to the on-demand RS/SIB request. The method may further involve the apparatus transmitting the response to the UE. The method may further involve the apparatus transmitting an on-demand RS/SIB according to the response.

In one aspect, an apparatus may comprise a transceiver which, during operation, wirelessly communicates with at least one network node of a wireless network. The apparatus may also comprise a processor communicatively coupled to the transceiver. The processor, during operation, may perform operations comprising determining whether to perform a measurement outside a measurement gap for a neighboring cell. The processor may also perform operations comprising applying a scheduling restriction within a time period in an event that the measurement is determined. The processor may further perform operations comprising transmitting, via the transceiver, uplink symbols or receiving downlink symbols outside the time period with the scheduling restriction.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIOT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of energy waste in network under schemes in accordance with implementations of the present disclosure.

FIG. 2 is a diagram depicting an example scenario of network energy saving under schemes in accordance with implementations of the present disclosure.

FIG. 3 is a diagram depicting an example scenario of general procedure for UE initiated on-demand SSB request under schemes in accordance with implementations of the present disclosure.

FIG. 4 is a diagram depicting an example scenario of general procedure for the UE initiated on-demand SSB request based on a multi-stage beam sweeping under schemes in accordance with implementations of the present disclosure.

FIG. 5 is a diagram depicting an example scenario of on-demand SSB request signaling under schemes in accordance with implementations of the present disclosure.

FIG. 6 is a diagram depicting an example scenario of on-demand SSB signaling under schemes in accordance with implementations of the present disclosure.

FIG. 7 is a diagram depicting an example scenario of reported information in on-demand SSB request under schemes in accordance with implementations of the present disclosure.

FIG. 8 is a diagram depicting an example scenario of information provided by network node under schemes in accordance with implementations of the present disclosure.

FIG. 9 is a diagram depicting an example scenario of system information signaling under schemes in accordance with implementations of the present disclosure.

FIG. 10 is a diagram depicting an example scenario of trigger timing for on-demand SSB request under schemes in accordance with implementations of the present disclosure.

FIG. 11 is a diagram depicting an example scenario of on-demand SSB measurement under schemes in accordance with implementations of the present disclosure.

FIG. 12 is a diagram depicting an example scenario of UE assistant information under schemes in accordance with implementations of the present disclosure.

FIG. 13 is a diagram depicting an example scenario of conflict handling under schemes in accordance with implementations of the present disclosure.

FIG. 14 is a diagram depicting an example scenario of UE capability report under schemes in accordance with implementations of the present disclosure.

FIG. 15 is a diagram depicting an example scenario of location information reporting under schemes in accordance with implementations of the present disclosure.

FIG. 16 is a diagram depicting an example scenario of voting-based request under schemes in accordance with implementations of the present disclosure.

FIG. 17 is a block diagram of an example communication system in accordance with an implementation of the present disclosure.

FIG. 18 is a flowchart of an example process in accordance with an implementation of the present disclosure.

FIG. 19 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to using on-demand reference signal for network energy saving with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

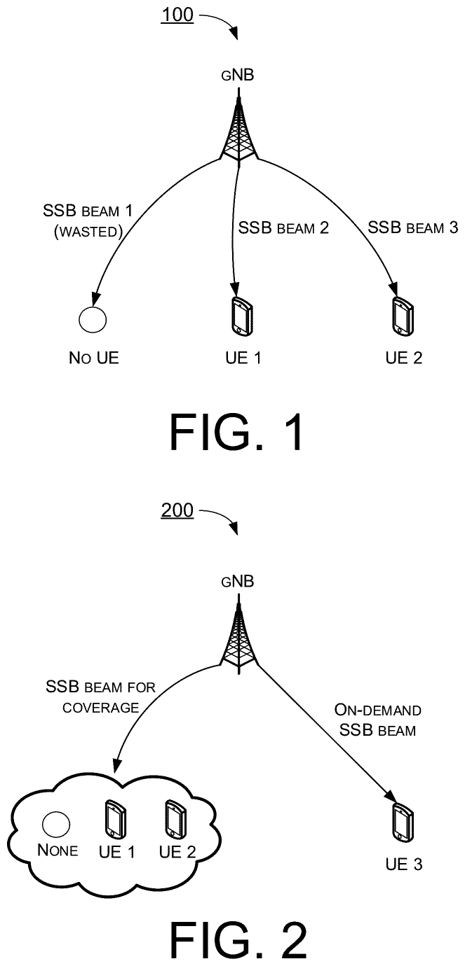

FIG. 1 illustrates an example scenario 100 of energy waste in a network under schemes in accordance with implementations of the present disclosure. Scenario 100 involves at least one network node (e.g., gNB) and a plurality of UEs, which may be a part of a wireless communication network (e.g., an LTE network, a 5G/NR network, an IoT network or a 6G network). Generally, the gNB needs to broadcast RSs in all beams or a wide range of beams (e.g., RS beam 1, RS bema 2 and RS beam 3) for wide coverage. However, when the traffic load is low or no UE is present in some areas, the gNB may waste energy on broadcasting the unnecessary RS. For example, there is no UE in the direction of RS beam 1, but the gNB still keep broadcasting the RS. This will degrade network energy efficiency and waste network resources.

In order to reduce network energy consumption, a network may reduce the number of SSB (e.g., from 8 to 4 for FR1) to maintain the coverage. If X number of SSB transmission needs X watts for a gNB, only broadcasting half SSB can achieve potential energy savings by half (e.g., X/2 watts). In addition, if SSB transmission time can be less, gNB may stay in a sleep mode longer. Depending on the network requirement, the network can selectively transmit only a few SSB and inform UE of which SSBs are transmitted and not transmitted. For example, when every SSBs are transmitted, the bitmap is set with all the bits being set to be 1 (e.g., ssb-PositionsInBurst CHOICE {mediumBitmap=11111111}). If only SSB 0, 1, 2 and 3 are transmitted, the bitmap is set with half bits being set to be 0 (e.g., ssb-PositionsInBurst CHOICE {mediumBitmap=11110000}). For an SSB periodicity of 5 ms, because the SSB duration is reduced from 4 ms (subframe 0, 1, 2, and 3) to 2 ms (subframe 0 and 1), a 3GPP NR cell can stay in sleep mode from 1 ms to 3 ms, which leads to a sleeping ratio from 20% to 60% (i.e., improve 40%). For an SSB periodicity of 20 ms, a 3GPP NR cell can stay in sleep mode from 16 ms to 18 ms, which leads to a sleeping ratio from 80% to 90% (i.e., improve 10%).

On the other hand, a network may also increase the SSB periodicity (e.g., from 5 ms to 20 ms) for network energy saving. For example, the UE may assume a default SSB periodicity as 20 ms and the network can configure {5, 10, 20, 40, 80, 160} ms. If the SSB periodicity/offset/duration configuration (e.g., SMTC) is not provided (e.g., for initial access), increasing the SSB period from 5 ms to 20 ms may achieve 61.5% power-saving gain when an sleep mode is used. If the SSB periodicity/offset/duration configuration (e.g., SMTC) is provided (e.g., for SCell operation), the SSB period of 160 ms is supported. Increasing the SSB period from 5 ms to 160 ms may achieve 82.3% power-saving gain when an advanced sleep mode is used.

One of network energy saving approaches is to reduce the number of SSB beams when the network is idle or during low and medium load periods. However, it may create a coverage hole that degrades initial access performance, and there would be a risk of reducing user throughputs at the cell edge. For example, increasing the number of SSBs may raise beamforming gain when the number of SSBs is increased from 4 to 8. Conversely, when a gNB reduces the number of SSBs for power saving, a UE may experience a beamforming gain loss. Another approach is to increase the SSB period during low and medium loads. However, it may degrade cell search performance, degrade radio resource management (RRM) accuracy and increase initial access delay. For example, it will increase the UE initial access delay. The UE needs more time to search for the synchronization signals over many synchronization channel frequency candidates and collect multiple SSB samples to achieve time diversity. Besides, it will increase UE power consumption in initial access and under out-of-coverage. Longer latency due to longer SS periodicity will lead to higher UE power consumption. When the UE enters the out-of-coverage area, the UE needs to perform periodic searches with a longer duration, which will lead to battery drain.

In view of the above, the present disclosure proposes several schemes pertaining to on-demand reference signal for network energy saving with respect to UE and network apparatus in mobile communications. A network node may turn off some RS (e.g., SSB) beams and keep the minimum RS beams to guarantee coverage. Meanwhile, the UE may request RS (e.g., SSB/SIB1) beams and periodicity to satisfy a reference signal received power (RSRP) and/or a service quality (e.g., QoS). The benefits of on-demand SSB are related to enhanced network resource efficiency by focusing on targeted SSB transmissions and thus minimizing unused SSB resources from beam sweeping across all beam directions. If a network node (e.g., gNB) is allowed to enter the energy-saving state (e.g., due to the current traffic below a given threshold), the network node may stop SSB beam sweeping and broadcast fixed and wide SSB beams.

In a case that the time-criticality of UE traffic, priority, expected volume cannot be satisfied, the UE may initiate a request for on-demand SSB resources and provide preferred parameters (e.g., SSB offset and periodicity, beam direction, or positions in time). In a case that the idle network is unaware of the UE presence in a cell, mobility, location coverage, etc. In general, the network is unaware of the time-criticality of UE traffic, priority, expected volume, etc. The UE may further report some assistant information (e.g., an on-demand SSB request) to facilitate the network achieving energy efficiency. Accordingly, the UE is able to request the on-demand RS/SIB to satisfy its requirements and the network node is able to enter an energy-saving state to save network energy. Some balances can be achieved between network energy saving and UE performance requirements.

FIG. 2 illustrates an example scenario 200 of network energy saving under schemes in accordance with implementations of the present disclosure. Scenario 200 involves at least one network node (e.g., gNB) and a plurality of UEs, which may be a part of a wireless communication network (e.g., an LTE network, a 5G/NR network, an IoT network or a 6G network). The gNB may enter into an energy-saving state and broadcast RS on a minimum/reduced number of beams for a basic/major coverage. For example, UE 1 and UE 2 are within the coverage of RS beams and can receive RS normally. The gNB may be configured to stop broadcasting some RS beams when in the energy-saving state. For example, UE 3 is in the coverage hole of the gNB under the energy-saving state. In order to get RS from the gNB, UE 3 may be configured to initiate an on-demand RS/SIB request in an event that a trigger condition is satisfied. Then, the gNB may transmit an on-demand RS/SIB to UE 3 based on its request. Thus, the gNB does not need to broadcast RS in a wide beam range or all beams for a long period of time. The gNB can reduce the number of RSs and/or RS beams for energy saving. Accordingly, the gNB can achieve better energy efficiency without wasting energy in some beam directions.

It should be noted that the on-demand RS/SIB mentioned in the present disclosure is not limited to an on-demand SSB but can be applied for other on-demand reference signals comprising, for example but not limited to, a channel state information-reference signal (CSI-RS), phase tracking-reference signal (PT-RS), data network-reference signal (DN-RS), positioning reference signal (PRS), SIB1 or reference signal from a transmission/reception point (TRP) or a neighbor cell.

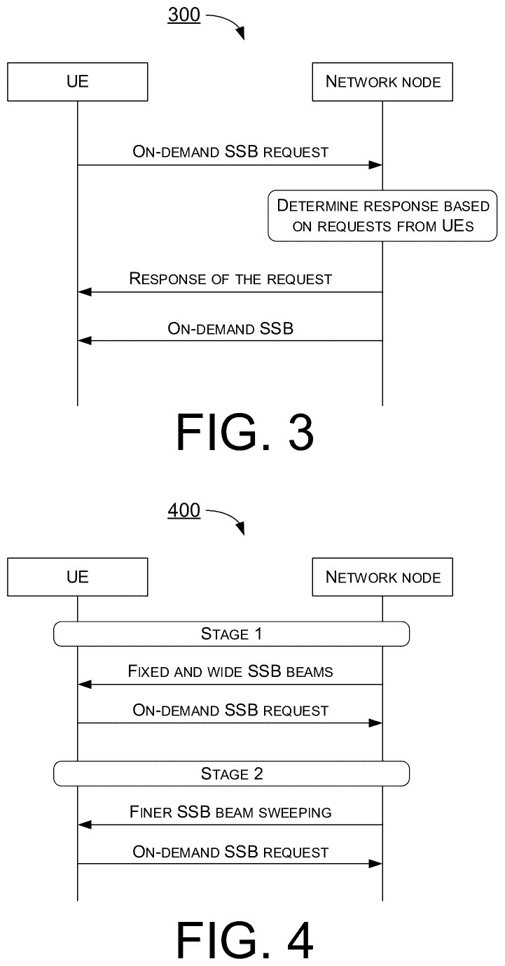

FIG. 3 illustrates an example scenario 300 of a general procedure for UE initiated on-demand SSB request under schemes in accordance with implementations of the present disclosure. Scenario 300 involves at least a network node (e.g., gNB) and a UE, which may be a part of a wireless communication network (e.g., an LTE network, a 5G/NR network, an IoT network or a 6G network). The UE may be configured to determine whether to trigger an on-demand SSB request according to a trigger condition. In an event that the trigger condition is satisfied, the UE may transmit the on-demand SSB request to the network node. The network node may determine a response for the on-demand SSB request. To determine the response, the network node may collect requests from more than one UEs and determine the final requests required to guarantee the performance. Then, the network node may transmit the on-demand SSB to the UE. The UE may receive the response of the on-demand SSB request and the on-demand SSB from the network node. The UE may perform an on-demand SSB measurement according to the response and the on-demand SSB.

FIG. 4 illustrates an example scenario 400 of a general procedure for the UE initiated on-demand SSB request based on a multi-stage beam sweeping under schemes in accordance with implementations of the present disclosure. Scenario 400 involves at least a network node (e.g., gNB) and a UE, which may be a part of a wireless communication network (e.g., an LTE network, a 5G/NR network, an IoT network or a 6G network). In stage 1, the UE may receive one or multiple fixed and wide beams form the network node. The UE may report at least one preferred wide beam direction (e.g., ssb-index) based on the L1-RSRP or L1-signal to interference plus noise ratio (SINR) to the network node. In stage 2, the UE may receive one or multiple fine beams targeted on UE's direction (e.g., finer SSB beam sweeping) form the network node. The UE may report at least one preferred fine beam direction to the network node. Then, the network node may transmit the on-demand SSB to the UE on the preferred fine beam direction. The UE may receive the on-demand SSB from the network node. The UE may perform the measurement on the on-demand SSB. In some implementations, more than two stages may be possible if the network node implements beam transmission in a nested structure (i.e., structures within structures).

For improving network energy efficiency, a network node/cell may be configured with different operation states. For example, a network node/cell may transit between an energy-saving state and a normal state (e.g., without energy saving) according to the traffic load. For the scenarios where a capacity booster cell is overlaid with the candidate cell(s), the capacity booster cell can autonomously decide to enter into the energy-saving state with lower energy consumption. The decision may be based on the load information of the related cells and the energy-saving policies (e.g., service-related information as one kind of energy-saving policy) set by operators. When a cell is in the energy-saving state, it may need other candidate cells to pick up the load. All traffic on that cell is expected to be drained to other overlaid/umbrella candidate cells before the cell moves to the energy-saving state. Besides, a cell in the energy-saving state should not cause coverage holes or create an undue burden on the surrounding cells.

The UE may receive an indication in SIB from the cell to indicate whether the cell is in an energy-saving state and/or whether the on-demand RS/SIB request is allowed. The UE may determine whether to camp on the cell. For example, the UE may determine whether to complete the cell selection/reselection process to choose the cell and start monitoring system information and paging information. The UE may transmit the on-demand RS/SIB request to the cell in an event that the cell is in the energy-saving state. If the cell is not in the energy-saving state, the UE is not allowed to transmit the on-demand RS/SIB request to the cell.

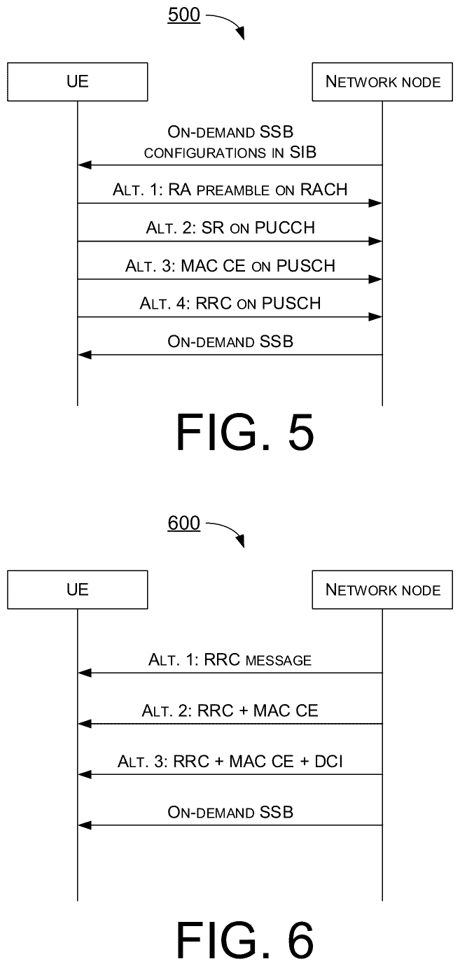

FIG. 5 illustrates an example scenario 500 of on-demand SSB request signaling under schemes in accordance with implementations of the present disclosure. Scenario 500 involves at least a network node (e.g., gNB) and a UE, which may be a part of a wireless communication network (e.g., an LTE network, a 5G/NR network, an IoT network or a 6G network). Scenario 500 illustrates some examples on how to signal the on-demand SSB request to the network node. The UE may transmit the on-demand SSB request in a random access preamble in random-access channel (RACH) via Msg 1 or Msg A. The UE may transmit a RA preamble inexplicitly/implicitly indicates a request for the on-demand SSB. The RACH may be a contention-based RA (CBRA) or a contention-free based (CFRA) RA via 2-step RACH or 4-step RACH. The UE may receive one or multiple recommending on-demand SSB configuration parameter sets via higher layer signaling (e.g., radio resource control (RRC) signaling). The UE may select one set from the received sets. The UE may indicate the recommended/preferred SSB configuration parameter set via a physical uplink shared channel (PUSCH) in Msg 3 or MSG-A.

In some implementations, the UE may transmit the on-demand SSB request via a scheduling request (SR) on a physical uplink control channel (PUCCH). The UE may transmit an SR indicating a request for the on-demand SSB. The UE may further indicate the recommended/preferred on-demand SSB configuration parameter set by a PUSCH scheduled by the network node responding to the SR.

In some implementations, the UE may transmit the on-demand SSB request via a media access control (MAC) control element (MAC CE) on a PUSCH. The UE may transmit a MAC CE on PUSCH indicating an on-demand SSB request. The MAC CE may further include the recommended/preferred on-demand SSB configuration parameter set.

In some implementations, the UE may transmit the on-demand SSB request via an RRC message on PUSCH. The UE may transmit an RRC message on PUSCH (e.g., UE assistance information, indicating a request for on-demand SSB). The RRC message may further include the recommended/preferred on-demand SSB configuration parameter set.

FIG. 6 illustrates an example scenario 600 of on-demand SSB signaling under schemes in accordance with implementations of the present disclosure. Scenario 600 involves at least a network node (e.g., gNB) and a UE, which may be a part of a wireless communication network (e.g., an LTE network, a 5G/NR network, an IoT network or a 6G network). Scenario 600 illustrates some examples on how to signal the on-demand SSB to the UE. The on-demand SSB may be initiated by the network node due to a request from a UE. In this case, the network node may transmit on-demand SSB resources via the following options. The network node may indicate the on-demand SSB transmission by an RRC signaling. The UE may receive the RRC message for periodical on-demand SSB transmission. The configuration parameters for periodical on-demand SSB transmission may be configured in the RRC signaling.

In some implementations, the network node may indicate the on-demand SSB transmission by a MAC CE. The UE may receive the MAC CE for semi-persistent on-demand SSB transmission. Multiple configuration parameter sets for semi-persistent on-demand SSB transmission may be configured in the RRC signaling. Then, one of them may be activated by the MAC CE.

In some implementations, the network node may indicate the on-demand SSB transmission by a downlink control information (DCI). The UE may receive a DCI format for semi-persistent and aperiodic on-demand SSB transmission. Multiple configuration parameter sets for semi-persistent and aperiodic on-demand SSB transmission may be configured in the RRC signaling. One of them may be activated by the DCI. Assuming that the number of configuration parameter sets is larger than the number of codepoints in the DCI. In that case, the MAC CE may activate some of the configuration parameter sets configured in the RRC signaling.

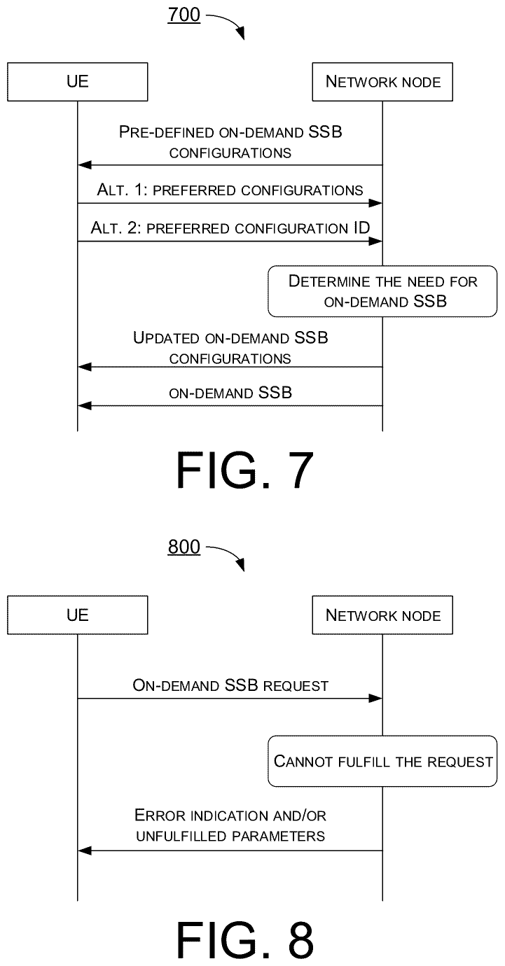

FIG. 7 illustrates an example scenario 700 of reported information in on-demand SSB request under schemes in accordance with implementations of the present disclosure. Scenario 700 involves at least a network node (e.g., gNB) and a UE, which may be a part of a wireless communication network (e.g., an LTE network, a 5G/NR network, an IoT network or a 6G network). Scenario 700 illustrates some examples on what information can be reported in the on-demand SSB request initiated by the UE. The network node may provide one or more pre-defined on-demand SSB configurations via higher layer signaling (e.g., RRC signaling or system information). Each pre-defined on-demand SSB configuration may corresponding to an identification (ID) and comprise a plurality of SSB parameters/configurations. To simplify the signaling, the UE may report a preferred on-demand SSB configuration ID based on pre-configured SSB parameters provided by the network node. Alternatively, the UE may determine some SSB parameters/configurations based on some assistance information provided by the network node. The UE may report the determined parameters/configurations to the network node. If the UE makes any request beyond the assistance information, the requested SSB might exceed the network's capability. To avoid such situation, the UE may only request SSB parameters/configurations within the scope of assistance data for an on-demand SSB request provided by the network node. Then, the network node may determine the need for the on-demand SSB based on the UE's request. The network node may provide the updated on-demand SSB configurations to the UE. The network node may transmit the on-demand SSB based on the updated configurations.

For the UE to report a preferred SSB configuration, the UE may receive the pre-configuration via SIB and RRC messages including, for example but not limited to, at least one of start/end time of SSB transmission (e.g., SMTC), SSB ID (e.g., ssb-index), SSB set (e.g., ssb-ToMeasure), SSB periodicity and offset, SSB subcarrier offset (e.g., ssb-SubcarrierOffset), beam directions (e.g., ssb-PositionQCL), ON/OFF indicator of on-demand SSB transmission, SSB subcarrier spacing (e.g., ssbSubcarrierSpacing), maximum number of SSB (e.g., short/medium/longBitmap), SSB position (e.g., ssb-PositionsInBurst) and SSB priority.

For the UE to request SSB parameters, the UE may transmit a request for on-demand SSB parameters including, for example but not limited to, at least one of start/end time of SSB transmission (e.g., SMTC), SSB ID (e.g., ssb-index), SSB set (e.g., ssb-ToMeasure), SSB periodicity and offset, SSB subcarrier offset (e.g., ssb-SubcarrierOffset), beam directions (e.g., ssb-PositionQCL), ON/OFF indicator of on-demand SSB transmission, SSB subcarrier spacing (e.g., ssbSubcarrierSpacing), maximum number of SSB (e.g., short/medium/longBitmap), SSB position (e.g., ssb-PositionsInBurst) and SSB priority.

In more detail, the field of beam direction may indicate the recommended quasi-colocation (QCL) relation between SS/physical broadcast channel (PBCH) blocks. The UE may send a DL RS resource ID and/or a QCL source to the network node to inform its preferable beam direction so that the on-demand SSN can be sent with the direction. The field of ON/OFF request may indicate the recommended indication to switch ON/OFF on-demand SSB transmission, which could be per SSB frequency, cell, TRP, or SSB. The ON request is a message to start the on-demand SSB transmission. The OFF request is a message to fall back to the SSB transmission with the basic configurations.

The field of start/end time may indicate a recommended measurement timing configuration. If this field is absent, the UE may assume that the SSB periodicity is 5 ms (e.g., a default value) for the on-demand SSB. The field of SSB periodicity and offset may indicate a recommended periodicity of on-demand SSB allocation in slots and the slot offset with respect to system frame number (SFN) 0 and slot number 0. The field of SSB subcarrier offset may indicate a recommended frequency domain offset between SSB and the overall resource block grid in a number of subcarriers. The field of SSB ID may indicate a recommended SS/PBCH index of the SS/PBCH block. The field of SSB set may indicate a recommended set of SS blocks to be measured within the SMTC measurement duration. When the field is absent, the UE may measure on all SS blocks.

The field of SSB group presence may indicate a recommended group of SSB indices. The first/leftmost bit may correspond to the SS/PBCH index 0-7. The second bit may correspond to SS/PBCH block 8-15 and so on. Value 0 in the bitmap may indicate that the SSBs according to inOneGroup are absent. Value 1 may indicate that the SS/PBCH blocks are transmitted by inOneGroup. The field of SSB inOneGroup may indicate a recommended SSB index based on the SSB group presence. The first/leftmost bit may correspond to the first SS/PBCH block index in the group (i.e., to SSB index 0, 8 and so on). The second bit may correspond to the second SS/PBCH block index in the group (i.e., to SSB index 1, 9 and so on) and so on. Value 0 in the bitmap may indicate that the corresponding SS/PBCH block is not transmitted. The value 1 may indicate that the corresponding SS/PBCH block is transmitted.

The field of SSB subcarrier spacing may indicate a recommended subcarrier spacing of SSB. For example, 15 kHz or 30 kHz in FR1 and 120 kHz or 240 kHz in FR2 are applicable. The field of number of SSB may indicate a recommended bitmap and a recommended maximum number of SS/PBCH blocks per half frame. The maximum number may be equal to 4, 8 or 64 which refer to short, medium or long bitmaps. The field of SSB position may indicate recommended time-domain positions of transmitted SS-blocks in a half-frame with SS/PBCH blocks. The first/leftmost bit may correspond to SS/PBCH block index 0. The second bit may correspond to SS/PBCH block index 1 and so on. Value 0 in the bitmap may indicate that the corresponding SS/PBCH block is not transmitted. The value 1 may indicate that the corresponding SS/PBCH block is transmitted.

The field of SSB priority may indicate a recommended priority of on-demand SSB reception compared to other DL signals and channels. The field of SSB half-frame index may indicate whether a preferred SSB is in the first half of the frame or the second half of the frame. Value zero may indicate the first half. Value 1 may indicate the second half. The field of SSB Subframe offset may indicate the subframe boundary offset of the cell in which the preferred SSB is transmitted. The field of SSB SFN offset may indicate the preferred time offset of the SFN 0 or slot 0 for the cell with respect to SFN 0 or slot 0 of the serving cell. The field of SFN SSB offset may indicate a preferred SFN offset of transmitted SSB relative to a start of an SSB period. Value 0 may indicate that the SSB is transmitted in the first system frame. Value 1 may indicate that SSB is transmitted in the second system frame and so on. The field of SSB frequency may indicate a preferred frequency of SSB. The field of SMTC duration may indicate a preferred duration of the measurement window in which to receive SS/PBCH blocks. It is given in a number of subframes.

The UE may further report why an on-demand SSB request is needed. It may be beneficial if the network has some understanding on the basis of why UE happens to request certain SSB characteristics. This may help the network learn and adapt to the desired SSB transmission efficiently. For example, the UE may report reasons comprising at least one of “no SSB can be detected”, “not enough resources”, “poor RSRP”, “QOS is not met” and “poor SINR”, etc.

FIG. 8 illustrates an example scenario 800 of information provided by network node under schemes in accordance with implementations of the present disclosure. Scenario 800 involves at least a network node (e.g., gNB) and a UE, which may be a part of a wireless communication network (e.g., an LTE network, a 5G/NR network, an IoT network or a 6G network). Scenario 800 illustrates some examples on what information can be provided by the network node in the response for the on-demand RS/SIB request. To avoid the initiation of invalid requests for the UE, the network node may provide the corresponding response for the on-demand SSB. After receiving the on-demand SSB request from the UE, the network may determine whether it can fulfil the request. The network may transmit a response or an indication to inform the determination result to the UE.

For example, the network may determine whether all the SSB configuration in the on-demand SSB request can be fulfilled or only a set of the parameters or none of the parameters within the SSB configuration in the on-demand PRS request can be fulfilled. The network may indicate an acceptance by an update of the on-demand SSB configuration or a one-bit accepted indication if all the requested SSB configurations can be fulfilled. Otherwise, the network may provide an error indication and/or the unfulfilled parameters requested by the UE.

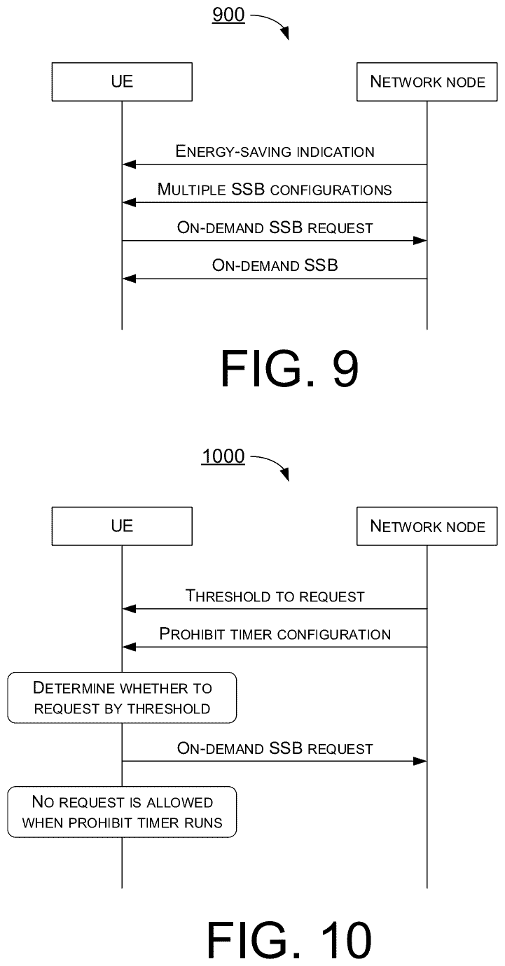

FIG. 9 illustrates an example scenario 900 of system information signaling under schemes in accordance with implementations of the present disclosure. Scenario 900 involves at least a network node (e.g., gNB) and a UE, which may be a part of a wireless communication network (e.g., an LTE network, a 5G/NR network, an IoT network or a 6G network). Scenario 900 illustrates some examples on what information can be provided by the network node in the system information signaling. The network node may signal predefined SSB configurations to the UE via system information (SI) and/or RRC messages. The network node may broadcast multiple sets of on-demand SSB configuration in the system information (e.g., SIB1, other SIBs or RRC message). The UE may request an on-demand SSB based on the broadcasted configurations considering its QOS requirements.

On the other hand, the network may indicate which cells/network nodes can support the on-demand SSB request. For example, the network may further broadcast an energy-saving state indicator for a serving cell. The indicator may have values ‘0’ and ‘1’. The value ‘0’ may represent that the cell is not in the energy-saving state. The value ‘1’ may represent that the cell is in the energy-saving state. The network node may determine whether to enter the energy-saving state based on the traffic load. The UE may only request on-demand SSB if the energy-saving state indicator is set to the value ‘1’.

FIG. 10 illustrates an example scenario 1000 of trigger timing for on-demand SSB request under schemes in accordance with implementations of the present disclosure. Scenario 1000 involves at least a network node (e.g., gNB) and a UE, which may be a part of a wireless communication network (e.g., an LTE network, a 5G/NR network, an IoT network or a 6G network). Scenario 1000 illustrates some examples on when the UE can transmit the on-demand SSB request. The trigger for an on-demand SSB request may be up to UE implementation or satisfy some conditions. The trigger condition may comprise at least one of a QoS requirement, an RSRP threshold, an SINR and whether an RS or SIB can be measured within a configured SMTC window or pre-defined resources. The UE may determine whether to trigger an on-demand SSB request based on its QOS requirement, L1-RSRP or L1-SINR measurement. For example, if the QoS requirement or the RSRP threshold cannot be met, the UE will initiate a request for on-demand SSB. The threshold may be configured by the network node via the RRC signaling or SIB broadcasting. The UE may determine to trigger an on-demand SSB request in an event that the UE cannot measure the SSB within the configured SMTC window or pre-defined resources (e.g., time-frequency resources).

When the UE cannot measure SSB within the configured SMTC window or pre-defined resources, the UE may initiate on-demand SSB based on the measurement result and/or UE location for expected SSB configurations. The network node may configure a threshold for a number of SSB detection failures. For example, the UE may trigger an on-demand SSB request if the number of failures is greater than 3. To avoid consecutive requests initiated by the UE, when an on-demand SSB request has been triggered, a prohibit timer configured by the network node may prevent the UE from initiating another request when the timer runs. The UE may receive the prohibit timer from the network node. The UE may stop transmitting the on-demand RS/SIB request to the network node when the prohibit timer is running.

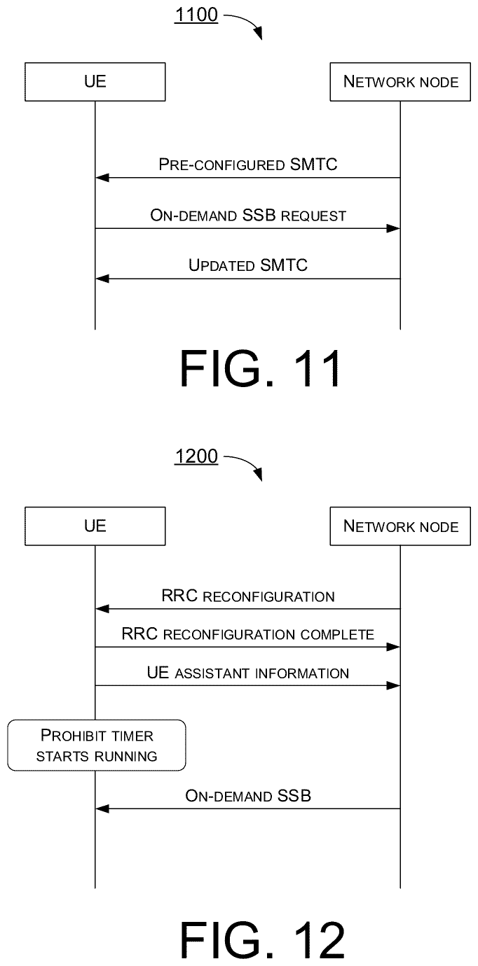

FIG. 11 illustrates an example scenario 1100 of on-demand SSB measurement under schemes in accordance with implementations of the present disclosure. Scenario 1100 involves at least a network node (e.g., gNB) and a UE, which may be a part of a wireless communication network (e.g., an LTE network, a 5G/NR network, an IoT network or a 6G network). Scenario 1100 illustrates some examples on when the UE should measure the on-demand SSB. The UE may determine the on-demand SMTC in accordance with the received periodicity and offset parameter in the SMTC1 or other SMTC configurations (e.g., pre-configured SMTC) provided by the network node. The first subframe of each SMTC occasion may occur at an SFN and subframe of the NR cell. The UE may request the network node to configure the on-demand SSB in a preferred measurement timing window (e.g., preferred SMTC). The UE may receive an updated SMTC and perform the on-demand RS/SIB measurement according to the updated SMTC. If the preferred SMTC is present, the UE may set up an additional SMTC in accordance with the received periodicity and offset parameters to monitor on-demand SSB occasions. The preferred SMTC request may include periodicity, time offset, window length, and the number of window occasions.

FIG. 12 illustrates an example scenario 1200 of UE assistant information under schemes in accordance with implementations of the present disclosure. Scenario 1200 involves at least a network node (e.g., gNB) and a UE, which may be a part of a wireless communication network (e.g., an LTE network, a 5G/NR network, an IoT network or a 6G network). Scenario 1200 illustrates some examples on transmitting on-demand SSB based on UE assistant information. The UE may report assistant information for the network node to determine which direction the on-demand SSB should be transmitted and the resources allocated to the on-demand SSB transmissions. The UE may transmit the assistant information to the network node and receive the on-demand RS/SIB corresponding to the assistant information. The UE assistant information reported from the UE to the network node may include L1-RSRP and/or L1-SINR reports or resource and/or resource set indices associated with DL RS (e.g., SSB reports). The UE assistant information may further include its preference on parameters of on-demand SSB comprising, for example but not limited to, at least one of start/end time of SSB transmission (e.g., SMTC), SSB ID (e.g., ssb-index), SSB set (e.g., ssb-ToMeasure), SSB periodicity and offset, SSB subcarrier offset (e.g., ssb-SubcarrierOffset), beam directions (e.g., ssb-PositionQCL), ON/OFF indicator of on-demand SSB transmission, SSB subcarrier spacing (e.g., ssbSubcarrierSpacing), the maximum number of SSB (e.g., short/medium/longBitmap), SSB position (e.g., ssb-PositionsInBurst) and SSB priority.

A UE capable of providing on-demand SSB assistance information in RRC_CONNECTED may initiate the procedure if configured to do so upon detecting low RSRP or upon detecting that QoS cannot be satisfied. The UE may be configured to initiate transmission of the UE assistance information message to provide an on-demand SSB request in an event that the UE is configured to provide an on-demand SSB request, the UE does not transmit a UE assistance information message with an on-demand SSB request since it was configured to provide the on-demand SSB request, or the preferred on-demand SSB is different from the one indicated in the last transmission of the UE assistance information message including an on-demand SSB request and a prohibit timer (e.g., T456 is not running). The UE may start or restart prohibit timer T456 with the timer value set to a value of an on-demand SSB request prohibit timer. The prohibit timer T456 may be started upon transmitting a UE assistance information message with an on-demand SSB request. The prohibit timer T456 may be stopped upon releasing the on-demand SSB request configuration during the connection re-establishment/resume procedures and upon receiving the on-demand SSB request configuration set to release. The prohibit timer T456 may have no action at expiry.

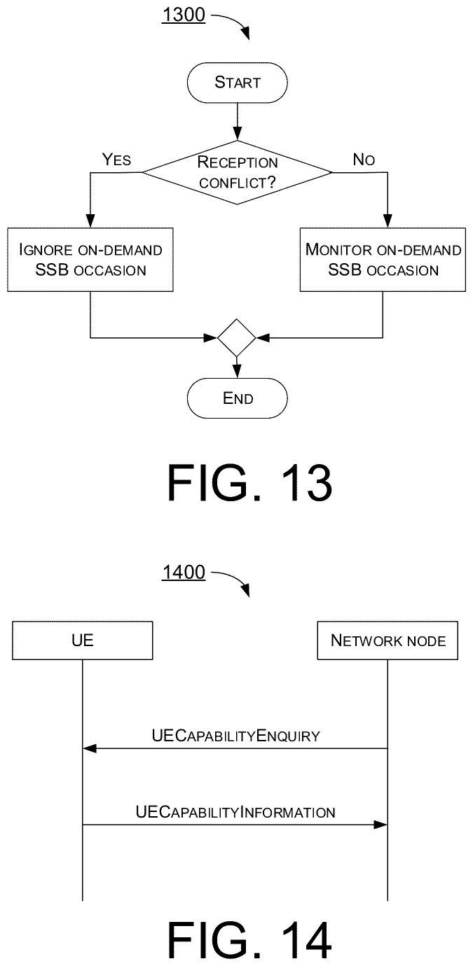

FIG. 13 illustrates an example scenario 1300 of conflict handling under schemes in accordance with implementations of the present disclosure. Scenario 1300 involves at least a network node (e.g., gNB) and a UE, which may be a part of a wireless communication network (e.g., an LTE network, a 5G/NR network, an IoT network or a 6G network). Scenario 1300 illustrates an example on conflict handling of the on-demand SSB. If the on-demand SSB and other UL/DL signal/channels (e.g., SSB, SIB1, CORESETO, MSG2/MSGB, paging or DL small data transmission (SDT)) overlap in time, reception of the on-demand SSB may have lower priority than other signal/channels. For example, if the UE determines a conflict between the on-demand SSB and other signals/channels reception, the UE may ignore the on-demand SSB reception or skip the on-demand SSB scheduling. For an idle or inactive UE, it may only monitor the DL always-on signal including SSB, SIB1, and PDCCH. When the UE detects the on-demand SSB and if the UE determines no conflicts between the on-demand SSB and other DL signals/channels reception, the detected on-demand SSB may be used.

FIG. 14 illustrates an example scenario 1400 of UE capability report under schemes in accordance with implementations of the present disclosure. Scenario 1400 involves at least a network node (e.g., gNB) and a UE, which may be a part of a wireless communication network (e.g., an LTE network, a 5G/NR network, an IoT network or a 6G network). Scenario 1400 illustrates an example on UE capability report for supportability of on-demand SSB. The UE may compile and transfer its UE capability information about whether on-demand RS/SIB is supported upon receiving an enquiry message (e.g., UECapabilityEnquiry) from the network node. The UE may report a capability information (e.g., UECapabilityInformation) to the network node to indicate whether the on-demand RS/SIB request is supported. UECapabilityEnquiry is an RRC message used by the network node that initiates the procedure to a UE in RRC_CONNECTED when it needs UE radio access capability information. For the UE supporting on-demand SSB, a UE capability report is needed for the network node to distinguish whether the UE supports on-demand SSB.

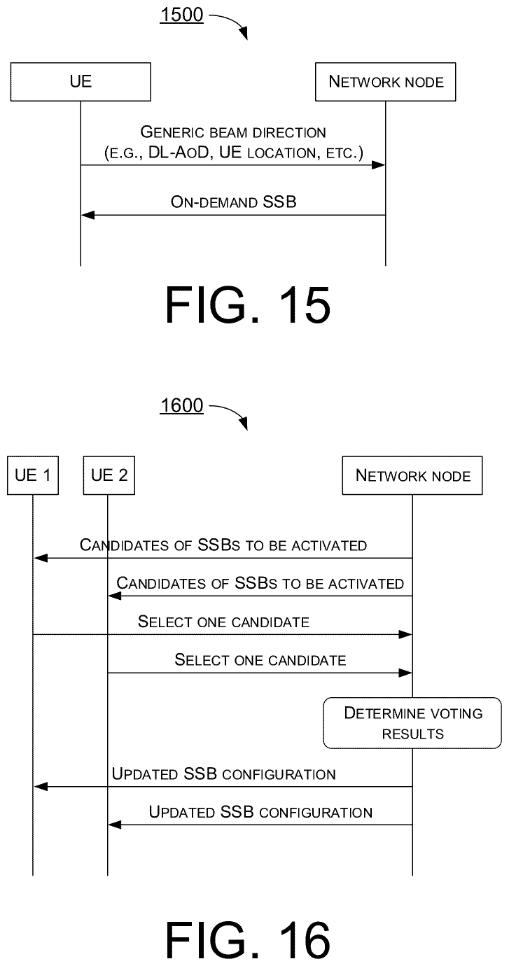

FIG. 15 illustrates an example scenario 1500 of location information reporting under schemes in accordance with implementations of the present disclosure. Scenario 1500 involves at least a network node (e.g., gNB) and a UE, which may be a part of a wireless communication network (e.g., an LTE network, a 5G/NR network, an IoT network or a 6G network). Scenario 1500 illustrates an example on reporting location-based information for on-demand SSB request. If the UE and the network node locations can be obtained, the UE may transmit a generic beam direction request for on-demand SSB beams (e.g., downlink angle of departure (DL-AoD) in azimuth and zenith). The network node may provide the on-demand SSB based on the request. This can prevent the UE from measuring SSBs and asking the network to transmit with the same spatial QCL as those SSBs. The UE may report global navigation satellite system (GNSS)-acquired location or other assistant information to help the network node provide a preferred beam direction for the on-demand SSB beams. The UE location report may be transmitted via a MAC CE during the random access procedure or an RRC message in RRC_CONNECTED. The UE location report may be initiated if configured to do so upon detecting low RSRP or upon detecting that QoS cannot be satisfied. The UE may transmit the report via a MAC CE command or an RRC message (e.g., UE assistant information on PUSCH). When radio link failure (RLF) happens, the UE may report UE assistant information (e.g., DL-AoD and UE location). The network node may use this information to turn on SSB beams, TRPs, cells, or base stations.

In some implementations, when a capacity booster cell enters into a sleep mode, it may disable initial access feature (e.g., using a few SSB beams or using a long SSB period (e.g., 160 ms)). In this case, the UE may not access directly from cell search. The network may provide a handover message or an SMTC configuration for the UE to access the capacity booster cell. The network may broadcast an indication in SIB whether neighbor cells have a long periodicity of SSBs or a small number of SSBs. The network may broadcast an indication whether a capacity booster cell is available. The UE may report its need (e.g., via UE assistant information) to request the network for providing a mean to access the capacity booster cell (e.g., a handover message or an SMTC configuration).

FIG. 16 illustrates an example scenario 1600 of voting-based request under schemes in accordance with implementations of the present disclosure. Scenario 1600 involves at least a network node (e.g., gNB) and a plurality of UEs, which may be a part of a wireless communication network (e.g., an LTE network, a 5G/NR network, an IoT network or a 6G network). Scenario 1600 illustrates an example on voting-based on-demand SSB request. The UE may receive an on-demand SSB request configuration initiated by the network node including a preference list of SSB indices (e.g., candidates of SSBs) that the network node would like to deactivate/activate. The UE capable of indicating its preference may initiate a transmission procedure upon configuration to provide its indication. A corresponding prohibit timer may start before/after sending the indication. A reference of the preference list may comprise at least one of a field of activation/deactivation, a field of SSB indices and a field of disagreement with the preference list. The UE may select one candidate and report to the network node. The network node may receive multiple preferred candidates from multiple UEs. The network node may determine voting results based on the received preferences. For example, the network node may determine an SSB configuration which is voted by most UEs. Then, the network node may transmit an updated SSB configuration to all the UEs.

### Illustrative Implementations

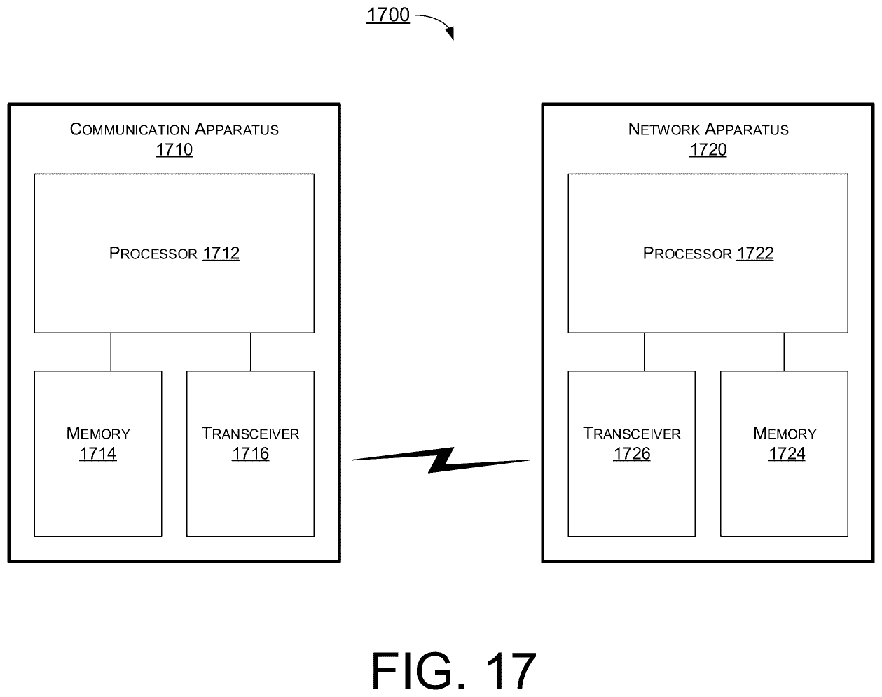

FIG. 17 illustrates an example communication system 1700 having an example communication apparatus 1710 and an example network apparatus 1720 in accordance with an implementation of the present disclosure. Each of communication apparatus 1710 and network apparatus 1720 may perform various functions to implement schemes, techniques, processes and methods described herein pertaining to using on-demand reference signal for network energy saving with respect to user equipment and network apparatus in mobile communications, including scenarios/schemes described above as well as processes 1800 and 1900 described below.

Communication apparatus 1710 may be a part of an electronic apparatus, which may be a UE such as a portable or mobile apparatus, a wearable apparatus, a wireless communication apparatus or a computing apparatus. For instance, communication apparatus 1710 may be implemented in a smartphone, a smartwatch, a personal digital assistant, a digital camera, or a computing equipment such as a tablet computer, a laptop computer or a notebook computer. Communication apparatus 1710 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 1710 may be implemented in a smart thermostat, a smart fridge, a smart door lock, a wireless speaker or a home control center. Alternatively, communication apparatus 1710 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 1710 may include at least some of those components shown in FIG. 17 such as a processor 1712, for example. Communication apparatus 1710 may further include one or more other components not pertinent to the proposed scheme of the present disclosure (e.g., internal power supply, display device and/or user interface device), and, thus, such component(s) of communication apparatus 1710 are neither shown in FIG. 17 nor described below in the interest of simplicity and brevity.

Network apparatus 1720 may be a part of a network apparatus, which may be a network node such as a satellite, a base station, a small cell, a router or a gateway. For instance, network apparatus 1720 may be implemented in an eNodeB in an LTE network, in a gNB in a 5G/NR, IoT, NB-IoT or IIOT network or in a satellite or base station in a 6G network. Alternatively, network apparatus 1720 may be implemented in the form of one or more IC chips such as, for example and without limitation, one or more single-core processors, one or more multi-core processors, or one or more RISC or CISC processors. Network apparatus 1720 may include at least some of those components shown in FIG. 17 such as a processor 1722, for example. Network apparatus 1720 may further include one or more other components not pertinent to the proposed scheme of the present disclosure (e.g., internal power supply, display device and/or user interface device), and, thus, such component(s) of network apparatus 1720 are neither shown in FIG. 17 nor described below in the interest of simplicity and brevity.

In one aspect, each of processor 1712 and processor 1722 may be implemented in the form of one or more single-core processors, one or more multi-core processors, or one or more CISC processors. That is, even though a singular term “a processor” is used herein to refer to processor 1712 and processor 1722, each of processor 1712 and processor 1722 may include multiple processors in some implementations and a single processor in other implementations in accordance with the present disclosure. In another aspect, each of processor 1712 and processor 1722 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1712 and processor 1722 is a special-purpose machine specifically designed, arranged and configured to perform specific tasks including autonomous reliability enhancements in a device (e.g., as represented by communication apparatus 1710) and a network (e.g., as represented by network apparatus 1720) in accordance with various implementations of the present disclosure.

In some implementations, communication apparatus 1710 may also include a transceiver 1716 coupled to processor 1712 and capable of wirelessly transmitting and receiving data. In some implementations, communication apparatus 1710 may further include a memory 1714 coupled to processor 1712 and capable of being accessed by processor 1712 and storing data therein. In some implementations, network apparatus 1720 may also include a transceiver 1726 coupled to processor 1722 and capable of wirelessly transmitting and receiving data. In some implementations, network apparatus 1720 may further include a memory 1724 coupled to processor 1722 and capable of being accessed by processor 1722 and storing data therein. Accordingly, communication apparatus 1710 and network apparatus 1720 may wirelessly communicate with each other via transceiver 1716 and transceiver 1726, respectively. To aid better understanding, the following description of the operations, functionalities and capabilities of each of communication apparatus 1710 and network apparatus 1720 is provided in the context of a mobile communication environment in which communication apparatus 1710 is implemented in or as a communication apparatus or a UE and network apparatus 1720 is implemented in or as a network node of a communication network.

In some implementations, processor 1712 may determine whether to trigger an on-demand RS/SIB request according to a trigger condition. Processor 1712 may transmit the on-demand RS/SIB request network apparatus 1720 in an event that the trigger condition is satisfied. Processor 1712 may receive a response of the on-demand RS/SIB request from network apparatus 1720. Processor 1712 may perform an on-demand RS/SIB measurement according to the response.

In some implementations, processor 1712 may receive an indication from network apparatus 1720 to indicate whether the on-demand RS/SIB request is allowed.

In some implementations, processor 1712 may receive at least one wide RS beam from network apparatus 1720. Processor 1712 may report at least one preferred wide RS beam to network apparatus 1720. Processor 1712 may receive at least one fine RS beam from network apparatus 1720. Processor 1712 may report at least one preferred fine RS beam to network apparatus 1720.

In some implementations, processor 1712 may receive an indication from network apparatus 1720 to indicate whether network apparatus 1720 is in an energy-saving state. Processor 1712 may transmit the on-demand RS/SIB request to network apparatus 1720 in an event that network apparatus 1720 is in the energy-saving state.

In some implementations, processor 1712 may transmit the on-demand RS/SIB request via at least one of a random access preamble, a scheduling request, a MAC CE and an RRC message.

In some implementations, processor 1712 may receive the response via at least one of an RRC message, a MAC CE and a DCI.

In some implementations, processor 1712 may report at least one preferred configuration or at least one preferred configuration ID of RS in the on-demand RS/SIB request. The at least one preferred configuration may comprise at least one of a beam direction, an RS period and offset, an RS subcarrier offset, an RS ID, an RS set, an RS subcarrier spacing, a number of RS, an RS position, an RS priority, an RS frequency and an SMTC duration.

In some implementations, the response of the on-demand RS/SIB request may comprise at least one of an update of an on-demand RS/SIB configuration, an acceptance indication, an error indication and an unfulfilled parameter. The trigger condition may comprise at least one of a QoS requirement, an RSRP threshold, an SINR measurement and whether an RS or SIB can be measured within a configured SMTC window or pre-defined resources.

In some implementations, processor 1712 may receive a prohibit timer from network apparatus 1720. Processor 1712 may stop transmitting the on-demand RS/SIB request to the network node when the prohibit timer is running.

In some implementations, processor 1712 may receive an updated SMTC. Processor 1712 may perform the on-demand RS/SIB measurement according to the updated SMTC.

In some implementations, processor 1712 may transmit an assistant information to network apparatus 1720. Processor 1712 may receive an on-demand RS/SIB corresponding to the assistant information.

In some implementations, processor 1712 may determine a conflict between an on-demand RS/SIB and a downlink reception. Processor 1712 may ignore or skip the on-demand RS/SIB.

In some implementations, processor 1712 may report a capability information to network apparatus 1720 to indicate whether the on-demand RS/SIB request is supported.

In some implementations, processor 1722 may an on-demand RS/SIB request from communication apparatus 1710. Processor 1722 may determine a response according to the on-demand RS/SIB request. Processor 1722 may transmit the response to communication apparatus 1710. Processor 1722 may transmit an on-demand RS/SIB according to the response.

In some implementations, processor 1722 may determine whether to enter into an energy-saving state. Processor 1722 may transmit an indication to communication apparatus 1710 in response to entering into the energy-saving state.

In some implementations, processor 1722 may determine whether the on-demand RS/SIB request can be fulfilled. Processor 1722 may transmit an acceptance indication to communication apparatus 1710 in an event that the on-demand RS/SIB request can be fulfilled. Processor 1722 may transmit an error indication or an unfulfilled parameter to communication apparatus 1710 in an event that the on-demand RS/SIB request cannot be fulfilled.

In some implementations, processor 1722 may broadcasting a plurality of on-demand RS/SIB configurations. Processor 1722 may receive at least one preferred configuration or at least one preferred configuration ID from communication apparatus 1710.

In some implementations, processor 1722 may receive an assistant information from communication apparatus 1710. Processor 1722 may transmit the on-demand RS/SIB according to the assistant information.

### Illustrative Processes

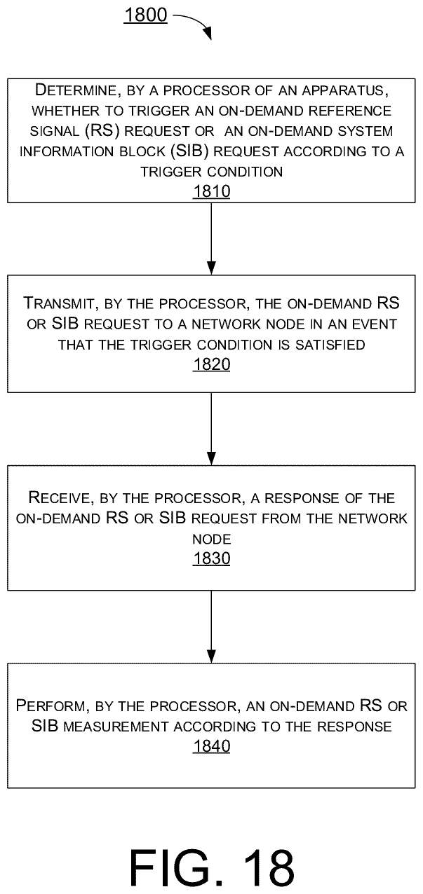

FIG. 18 illustrates an example process 1800 in accordance with an implementation of the present disclosure. Process 1800 may be an example implementation of above scenarios/schemes, whether partially or completely, with respect to using on-demand reference signal for network energy saving with the present disclosure. Process 1800 may represent an aspect of implementation of features of communication apparatus 1710. Process 1800 may include one or more operations, actions, or functions as illustrated by one or more of blocks 1810, 1820, 1830 and 1840. Although illustrated as discrete blocks, various blocks of process 1800 may be divided into additional blocks, combined into fewer blocks, or eliminated, depending on the desired implementation. Moreover, the blocks of process 1800 may be executed in the order shown in FIG. 18 or, alternatively, in a different order. Process 1800 may be implemented by communication apparatus 1710 or any suitable UE or machine type devices. Solely for illustrative purposes and without limitation, process 1800 is described below in the context of communication apparatus 1710. Process 1800 may begin at block 1810.

At 1810, process 1800 may involve processor 1712 of communication apparatus 1710 determining whether to trigger an on-demand RS/SIB request according to a trigger condition. Process 1800 may proceed from 1810 to 1820.

At 1820, process 1800 may involve processor 1712 transmitting the on-demand RS/SIB request to a network node in an event that the trigger condition is satisfied. Process 1800 may proceed from 1820 to 1830.

At 1830, process 1800 may involve processor 1712 receiving a response of the on-demand RS/SIB request from the network node. Process 1800 may proceed from 1830 to 1840.

At 1840, process 1800 may involve processor 1712 performing an on-demand RS/SIB measurement according to the response.

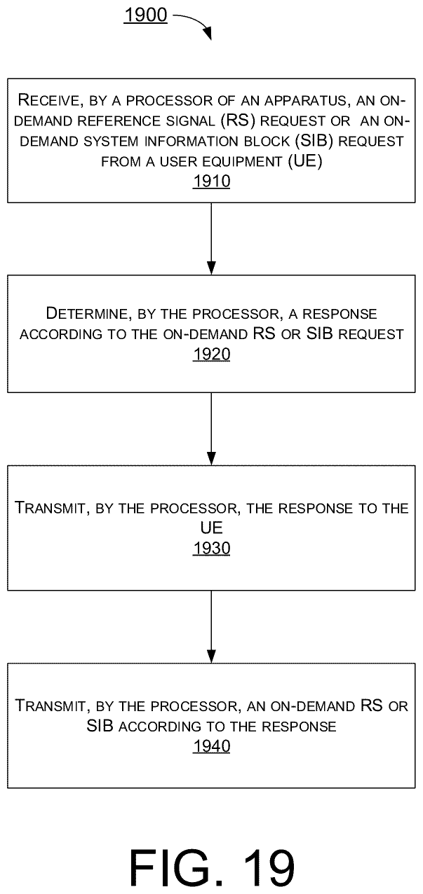

FIG. 19 illustrates an example process 1900 in accordance with an implementation of the present disclosure. Process 1900 may be an example implementation of above scenarios/schemes, whether partially or completely, with respect to using on-demand reference signal for network energy saving with the present disclosure. Process 1900 may represent an aspect of implementation of features of network apparatus 1720. Process 1900 may include one or more operations, actions, or functions as illustrated by one or more of blocks 1910, 1920, 1930 and 1940. Although illustrated as discrete blocks, various blocks of process 1900 may be divided into additional blocks, combined into fewer blocks, or eliminated, depending on the desired implementation. Moreover, the blocks of process 1900 may be executed in the order shown in FIG. 19 or, alternatively, in a different order. Process 1900 may be implemented by network apparatus 1720 or any base stations or network nodes. Solely for illustrative purposes and without limitation, process 1900 is described below in the context of network apparatus 1720. Process 1900 may begin at block 1910.

At 1910, process 1900 may involve processor 1722 of network apparatus 1720 receiving an on-demand RS/SIB request from communication apparatus 1710. Process 1900 may proceed from 1910 to 1920.

At 1920, process 1900 may involve processor 1722 determining a response according to the on-demand RS/SIB request. Process 1900 may proceed from 1920 to 1930.

At 1930, process 1900 may involve processor 1722 transmitting the response to communication apparatus 1710. Process 1900 may proceed from 1930 to 1940.

At 1940, process 1900 may involve processor 1722 transmitting an on-demand RS/SIB according to the response.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of an apparatus, whether to trigger an on-demand reference signal (RS) request or an on-demand system information block (SIB) request according to a trigger condition;
transmitting, by the processor, the on-demand RS or SIB request to a network node in an event that the trigger condition is satisfied;
receiving, by the processor, a response of the on-demand RS or SIB request from the network node; and
performing, by the processor, an on-demand RS or SIB measurement according to the response.

2. The method of claim 1, further comprising:
receiving, by the processor, an indication from the network node to indicate whether the on-demand RS or SIB request is allowed.

3. The method of claim 1, further comprising:
receiving, by the processor, at least one wide RS or SIB beam from the network node;
reporting, by the processor, at least one preferred wide RS or SIB beam to the network node;
receiving, by the processor, at least one fine RS or SIB beam from the network node; and
reporting, by the processor, at least one preferred fine RS or SIB beam to the network node.

4. The method of claim 1, further comprising:
receiving, by the processor, an indication from the network node to indicate whether the network node is in an energy-saving state; and
transmitting, by the processor, the on-demand RS or SIB request to the network node in an event that the network node is in the energy-saving state.

5. The method of claim 1, wherein the transmitting comprises transmitting the on-demand RS or SIB request via at least one of a random access preamble, a scheduling request, a media access control (MAC) control element (CE) and a radio resource control (RRC) message.

6. The method of claim 1, wherein the receiving comprises receiving the response via at least one of a radio resource control (RRC) message, a media access control (MAC) control element (CE) and a downlink control information (DCI).

7. The method of claim 1, further comprising:
reporting, by the processor, at least one preferred configuration or at least one preferred configuration identify (ID) of RS in the on-demand RS or SIB request.

8. The method of claim 7, wherein the at least one preferred configuration comprises at least one of a beam direction, an RS period and offset, an RS subcarrier offset, an RS ID, an RS set, an RS subcarrier spacing, a number of RS, an RS position, an RS priority, an RS frequency and a synchronization signal block (SSB)-based measurement timing configuration (SMTC) duration.

9. The method of claim 1, wherein the response of the on-demand RS or SIB request comprises at least one of an update of an on-demand RS or SIB configuration, an acceptance indication, an error indication and an unfulfilled parameter.

10. The method of claim 1, wherein the trigger condition comprises at least one of a quality of service (QOS) requirement, a reference signal received power (RSRP) threshold, a signal to interference plus noise ratio (SINR) measurement and whether an RS or SIB can be measured within a configured synchronization signal block (SSB)-based measurement timing configuration (SMTC) window or pre-defined resources.

11. The method of claim 1, further comprising:
receiving, by the processor, a prohibit timer from the network node; and
stopping, by the processor, transmitting the on-demand RS or SIB request to the network node when the prohibit timer is running.

12. The method of claim 1, further comprising:
receiving, by the processor, an updated synchronization signal block (SSB)-based measurement timing configuration (SMTC); and
performing, by the processor, the on-demand RS or SIB measurement according to the updated SMTC.

13. The method of claim 1, further comprising:
transmitting, by the processor, an assistant information to the network node; and
receiving, by the processor, an on-demand RS or SIB corresponding to the assistant information.

14. The method of claim 1, further comprising:
determining, by the processor, a conflict between an on-demand RS or SIB and a downlink reception; and
ignoring or skipping, by the processor, the on-demand RS or SIB.

15. The method of claim 1, further comprising:
reporting, by the processor, a capability information to the network node to indicate whether the on-demand RS or SIB request is supported.

16. A method, comprising:
receiving, by a processor of an apparatus, an on-demand reference signal (RS) request or an on-demand system information block (SIB) request from a user equipment (UE);
determining, by the processor, a response according to the on-demand RS or SIB request;
transmitting, by the processor, the response to the UE; and
transmitting, by the processor, an on-demand RS or SIB according to the response.

17. The method of claim 16, further comprising:
determining, by the processor, whether to enter into an energy-saving state; and
transmitting, by the processor, an indication to the UE in response to entering into the energy-saving state.

18. The method of claim 16, further comprising:
determining, by the processor, whether the on-demand RS or SIB request can be fulfilled;
transmitting, by the processor, an acceptance indication to the UE in an event that the on-demand RS or SIB request can be fulfilled; or
transmitting, by the processor, an error indication or an unfulfilled parameter to the UE in an event that the on-demand RS or SIB request cannot be fulfilled;

19. The method of claim 16, further comprising:
broadcasting, by the processor, a plurality of on-demand RS or SIB configurations; and
receiving, by the processor, at least one preferred configuration or at least one preferred configuration identify (ID) from the UE.

20. The method of claim 16, further comprising:
receiving, by the processor, an assistant information from the UE; and
transmitting, by the processor, the on-demand RS or SIB according to the assistant information.
